(19) United States
(12) Patent Application Publication
(10) Pub. No.: US 2013/0242051 A1
(43) Pub. Date: Sep. 19, 2013

(54) Image Coding And Decoding Method And Apparatus For Efficient Encoding And Decoding Of 3D Light Field Content

(71) Applicant: Tibor Balogh, Budapest (HU)

(72) Inventor: Tibor Balogh, Budapest (HU)

(21) Appl. No.: 13/989,912

(22) PCT Filed: Nov. 29, 2011
(86) PCT No.: PCT/HU11/00115

§ 371 Date: May 28, 2013

(30) Foreign Application Priority Data
Nov. 29, 2010 (HU) P 10 00640

(51) Int. Cl. H04N 7/32

(52) U.S. Cl. CPC H04N 19/00769
USPC 348/43

(57) ABSTRACT

The invention is an image coding method for video compression, especially for efficient encoding and decoding of true 3D content, without extreme bandwidth requirements, being compatible with the current standards serving as an extension, providing a scalable format. The method comprises of the steps of obtaining geometry-related information about the 3D geometry of the 3D scene and generating a common relative motion vector set on the basis of the geometry-related information, the common relative motion vector set corresponding to the real 3D geometry. This motion vector generating step (37) replaces conventional motion estimation and motion vector calculation applied in the standard (MPEG4/H.264 AVC, MVC, etc.) procedures. Inter-frame coding is carried out by creating predictive frames, starting from an intra frame, being one of the 2D view images on the basis of the intra frame and the common relative motion vector set. On the decoder side large number of views are reconstructed based on dense, but real 3D geometry information. The invention also relates to image coding and decoding apparatuses carrying out the encoding and decoding methods, as well as to computer readable media storing computer executable instructions for the inventive methods. (FIG. 8)

### TECHNICAL FIELD

The invention relates to a method for video compression, especially for efficient encoding and decoding of moving image (motion picture) data comprising 3D content. The invention also relates to picture coding and decoding apparatuses carrying out the coding and decoding methods, as well as to computer readable media storing computer executable instructions for the inventive methods.

### BACKGROUND ART

In a 3D image there is much more information than in a similar 2D image. To be able to reconstruct a complex 3D scene, a large number of 2D views are necessary. For the proper quality reconstruction of a 3D light field, as appears in a natural view, i.e. for having a sufficiently wide field-of-view (FOV) and good depth, the number of views can be in the range of around 100. The problem is that the transmission of such a 3D content would also require about 100× bandwidth, which is unacceptable in practice.

On the other hand the 2D view images of a 3D scene are not independent of each other, there is determined geometrical relation and a strong correlation between the view images that can be exploited for an efficient compression.

Conventional displays, TV sets show 2D images, where there is no 3D information available. Stereoscopic displays are able to provide two views, L&R (left and right) images, that give depth information from one single viewpoint. At stereoscopic displays viewers have to wear glasses to separate the views, or in case of autostereo, i.e. non-glasses systems they should be positioned in one viewpoint, the so called sweet spot, where they can see the two images separately. Among the autostereo systems multiview displays supply 5-16, typically 8-9 views, allowing a glasses-free 3D effect in a narrow, typically a few degrees viewing zone, which however is periodically repeated with invalid zones in between at current known systems. There is a need for sophisticated 3D technologies, providing real 3D experience, while keeping the use comfort of usual 2D displays, where viewers do not have to wear glasses or be positioned.

As shown in FIG. 1, the light field is a general representation of 3D information that considers a 3D scene 11 as the collection of light beams that are emitted or reflected from 3D scene points. The visible light beams are described with respect to a reference surface S using the light beams' intersection with the surface and angle.

Light field 3D displays can provide a continuous undisturbed 3D view over a wide FOV, the range where viewers can freely move or located still seeing perfect 3D view. In such a 3D view the displayed objects or details of different depth move according to the rules of perspective as the viewer moves around. This change called also motion parallax, referring to 2D view images 13 of the 3D scene 11 holding parallax information. Theoretically the 3D light field is continuous, however it can be properly reconstructed from a large number of views 12, in the practice 50-100 views taken by cameras 10. In FIG. 1 a central view is represented by a center image C, views right from the center are represented by right images R₁ to Rₙ, and views left from the center are represented by left images L₁ to Lₙ. Throughout the specification and claims, the terms ‘picture’, image' and ‘frame’ are basically considered as synonyms and are understood in the broadest possible sense.

Current 3D compression technologies, mostly stereoscopic or multiview content come from the adaptation of existing 2D compression technologies. A multiview video coding method is disclosed in US 2009/0268816 A1.

The known Multiview Video Coding standard MPEG-4/H.264 AVC MVC (in the following: MVC standard) enables the construction of bitstreams that represent more than one view of a video scene. This MVC standard is basically an MPEG profile, with a specific syntax of parameterizing the encoders and decoders in order to achieve certain increase in the compression efficiency depending on which spatial-temporal neighbors the images are predicted.

In FIG. 2, a prediction structure of the MVC standard is shown depicting the pictures (i.e. frames) in a matrix according to the temporal and the spatial axes. The horizontal is the time, along the vertical axis are the spatially displaced view images. The frames adjacent in time or space/view direction show the strongest similarity.

According to the standard notation the image (i.e. picture) indicated by I is an intra frame (also called key-frame), which is compressed independently by its own, based only on internal correspondences of its image parts. A P frame stands for a predictive frame, which is predicted from an other frame, which can be either an I frame or a P frame, based on given temporal or spatial correlation between the frames. A B frame originally refers to bi-directional frames, which are predicted from two directions, e.g. two neighbors preceding and succeeding in time. In the MVC generalizing dependencies, hierarchical B frames of multiple references are also meant, frames that refer to multiple pictures in the prediction process to enhance efficiency.

The MVC standard serves to exploit spatial correspondences present in the frames belonging to different views of a 3D scene to reduce spatial redundancy along with the temporal redundancy. It uses standard H.264 codecs, incl. motion estimation-compensation and recommends various prediction structures to achieve better compression rates by predicting frames from all of their possible temporal/spatial neighbors.

Various combinations of prediction structures were tested against standard MPEG test sequences for the resulting gain in the compression rate relative to the standard H.264 AVC. According to the tests and measurements the difference is smaller between the time-wise neighboring pictures than the spatial neighbors, thus the relative gain is less for the spatial prediction, at views of larger disparities, than for the temporal prediction e.g. especially for static scenes. As of MVC average coding efficiency, a 20 to 30% gain in the bit rate can be reached (while at certain sequences there is no gain at all) and the data rate increases proportionally with the number of views, even if they belong the same 3D scene, holding partly overlapping image elements.

These conclusions, being contrary to our inventive concept, came from the fact, that the various parameterization/syntaxes of standard MPEG algorithms, originally developed for 2D, were used for the compression of the frame matrix containing 3D information, particularly, that for the motion estimation, motion vector generation the usual MPEG procedures, e.g. frame block segmentation, search strategies (e.g. full, 3 step, diamond, predictive), are applied.

On one hand the prediction task is similar for temporal and inter-view prediction, so it is obvious to use well developed algorithms not to send through repeating parts, on the other hand, however, in 2D the goal is different, because it is enough finding the “alike” and not the “same”.

The resulting motion vectors represent the best matching blocks in color and not necessarily the real motion or the displacement between the positions of an image part/block in one view image to the other view image. The search algorithm will find the nearest best matching color block (based e.g. on Sum of Absolute Differences, SAD; or Sum of Squared Errors, SSE; or Sum of Absolute Transform Differences, SATD) and will not continue searching even if it could find the same image element/ block some more pixels away.

Thus the conventional motion vector map does not match the actual motion of the image parts from one view to the other, in other words it does not match the disparity map describing the changes between 2D view images of a 3D scene based on the real 3D geometry.

In most cases the motion estimation, motion vector algorithms typically search the best matching blocks in the previous frame, thus this is not really a forward predictive rather a backward predictive process.

### DESCRIPTION OF THE INVENTION

It is an object of the invention to present a compression algorithm, which can provide a high quality 3D view without extreme bandwidth requirements, compatible with the current standards and can serve as an extension to it and provide a scalable format in the sense, that 2D, stereo, narrow angle multiview and wide angle 3D light field content are simultaneously available for the various (2D, stereo, autostereo) displays with their correspondingly parameterized decoders.

The objects of a 3D scene, i.e. the image parts on the 2D view image, shot from different positions from the 3D scene, move proportionally to the distance of the acquisition cameras from one view to the other. The relative positions in multiple camera images, practically for cameras displaced equally and directed to a virtual screen, the objects behind the screen move with the viewer, the objects in front of the screen move against, while details on the screen plane does not move at all, as the viewer, watching the individual views, walks from on view position to the other.

The displacement of image elements/objects may be used to set up a disparity map, in which the disparity values unambiguously correspond to the depth in the geometry of the 3D scene. The disparity map or depth map belonging to a view image is basically a 3D model containing the geometry information of the 3D scene from that viewpoint. Disparity and depth maps can be converted into each other using the acquisition camera parameters and arrangement geometry. In practice, disparity maps allow more precise image reconstruction, since depth maps does not scale linearly and depth steps sometimes correspond to disparity values in the fraction of the pixel size, furthermore disparity based image reconstruction performs better at mirror-like surfaces, where the color of the pixels can be in more complex relation with the depth.

Any 2D views of the 3D scene can be generated in case the full 3D model is available. In case the disparity map or depth map is available, a perfect neighboring view can be generated, except for the hidden details, by moving the image parts accordingly.

The disparity or depth maps are preferably pixel based, this is equivalent to having a motion vector set with motion vectors to each pixel. Currently in the MPEG the image is segmented into blocks and motion vectors are associated to the blocks rather than to pixels. This results in fewer motion vectors, thus the motion vector set represent a lower resolution model, which however can go up to 4×4 pixels resolution, and since objects usually cover areas of larger number of pixels, this precision describe well any 3D scene.

It has been recognized that in case motion vectors derived from the real 3D geometry are applied, either pixel or block based, for moving image parts, blocks, the neighboring views can be predicted very effectively. Thus large number of views can be reconstructed without transmitting huge amount of data and even for scenes of high 3D complexity it will be very few of residual correction image content that should be coded separately.

Thus, the invention is an image coding method according to claim 1, an image decoding method according to claim 13, an image coding apparatus according to claim 17, an image decoding apparatus according to claim 18, as well as computer readable media storing programs of the inventive methods according to claims 19 and 20.

According to the invention, geometry-related information is obtained, or preferably even the real/actual geometry of the 3D scene is determined by means of known processes. To this end, identical objects, image parts are identified in the 2D view images of the 3D scene, typically shot from different positions by multiple cameras directed to the 3D scene in a proper geometry. Alternatively, if the 3D scene is computer generated, the geometry-related information or the real/actual geometry is readily available.

Instead of the conventional motion estimation, motion vector calculation applied in the standard MPEG (H.264 AVC, MVC, etc.) procedures, motion vectors are determined according to the geometry based relative moves or disparities. These motion vectors set up a common relative motion vector set, which is common for at least some of the 2D view frames (thereby requiring less data for the coding), and is relative in the sense that it represents the relative movements from one view to the adjacent one. This common relative motion vector set can be preferably transmitted in line with the MPEG standard, or as an extension to it. On the decoder side a large number of views can be reconstructed on the basis of this single motion vector set, representing real 3D geometry information.

Thus a very effective coding method is obtained, that can perform inter-view compression highly effectively, and enables reduced storage capacity, or the transmission of true 3D, broad-baseline light-field content in a reasonable bandwidth.

The intra-frame only compression yields less gain relative to the inter-frame prediction based compression, where the strong correlation between the frames can be used to minimize the residual information to be coded. The practical values for intra-frame compression rate ranges from 7:1 to 25:1, while for the inter-frame compression the rate can go from 20:1 up to 300:1.

The inventive 3D content compression exploits the inherent geometry determined correlation between the frames. Thus the inventive method can be applied for any coding techniques using inter-frame coding, that is even not MPEG based, e.g. coding schemes using wavelet transformation instead of discreet cosine transformation (DCT). The method according to the invention gives a general approach to handle images containing 3D information, processing their essential elements in merit, by identifying the separate image elements, following their displacement over the view images as a consequence of their depth, removing all 3D based redundancy by processing the image elements and their motion common in the views, then generating multiple views at the decoder side using the image elements/segments and the disparity information related to them, followed by completing the views by the residuals.

### BRIEF DESCRIPTION OF DRAWINGS

Preferred embodiments of the invention will now be described by way of example with reference to drawings, in which

FIG. 1 is a schematic drawing showing a light field of a 3D scene, its reconstruction on a screen and acquisition through a large number of views taken by cameras;

FIG. 2. is a schematic diagram of the known MPEG-4/H.264 AVC, MVC prediction structure;

FIG. 3 shows common relative motion vectors describing the displacement of an image segment (image part) through all the views;

FIG. 4 shows an optimized relative motion vector set transmitted only with the changes of newly appearing details for frame prediction;

FIG. 5 shows a merged common relative motion vector set with individual relative motion vector sets for an inventive frame prediction;

FIG. 6 shows an MPEG-4/H.264 AVC, MVC compliant symmetric frame prediction structure that can be used in the invention;

FIG. 7 is a schematic diagram of generating additional views by interpolation and extrapolation at a decoder; and

FIG. 8. is a schematic block diagram of a encoding apparatus applying 3D geometry based disparity calculation and geometrically correct motion vector generation.

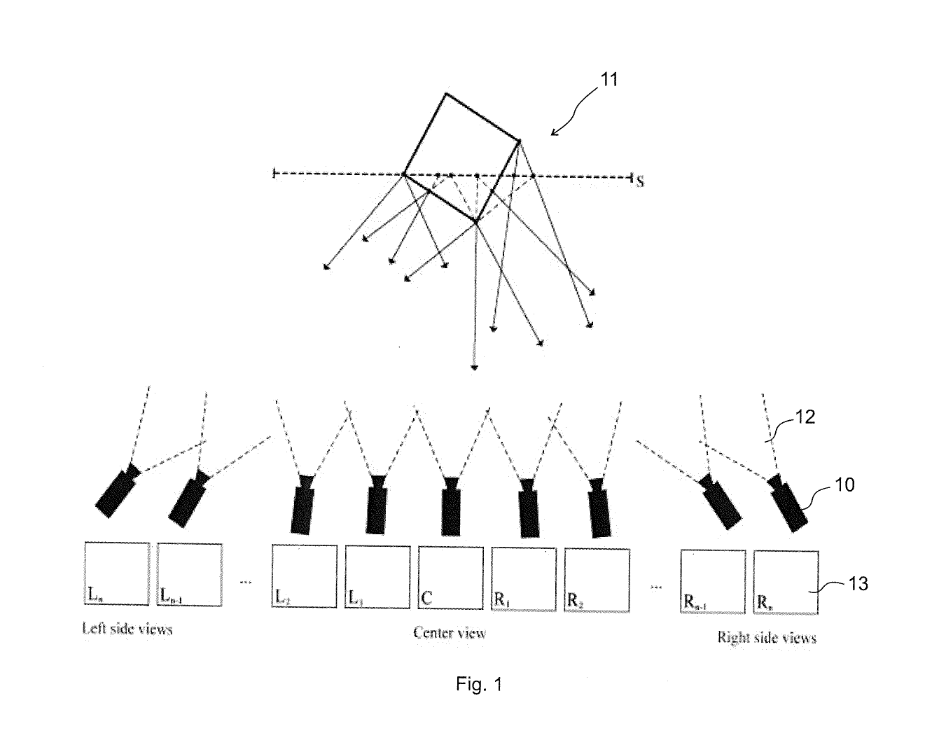

### MODES FOR CARRYING OUT THE INVENTION

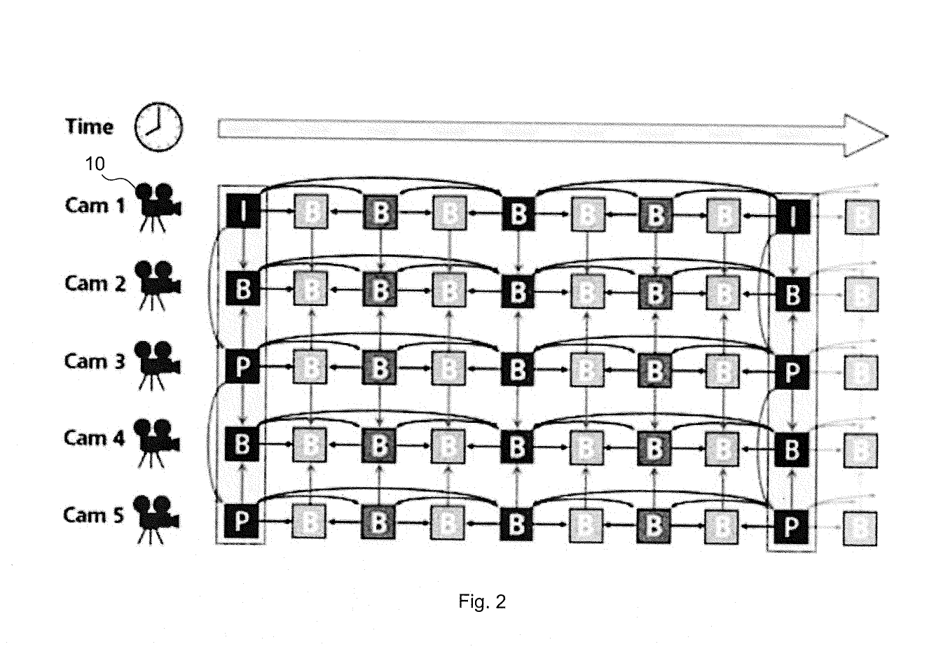

The known MVC applies the H.264 AVC scheme, supplying video images from multiple cameras to the encoder and with appropriate control using the inter-frame coding feature not only for the temporally correlated successive frames, but also for the spatially correlating neighboring views, as shown in FIG. 2. For the encoder it does not make any difference whether this is a temporal or spatial correlation, it always follows the same prediction strategy, by finding the best matching and not the same block to decrease the amount of data, and to remove all the spatial redundancy it does not exploit the 3D geometry relation present in the 2D view pictures of a 3D scene, resulting in the aforementioned limitations of the MVC coding.

The current invention, in contrary, focuses on the inherent 3D correspondence. Since 3D content compression is by nature an inter-frame coding task, the conventional motion estimation step is replaced with an actual 3D geometry calculation based on depth dependent disparity of image parts, and on this basis the real geometrical motion vectors are determined. The 2D view images from the cameras 10 serve as an input to the module to perform a robust 3D geometry analysis over multiple views.

Several procedures are known for determining the geometry model of a 3D scene from certain views, the question is rather the speed and accuracy of the given algorithm. In live real-time 3D video streaming 30 to 60 fames/sec operation is a requirement, slower algorithms can only be allowed in the post-processing of pre-recorded materials.

Multiple 2D view images of a 3D scene serve as the input. The images are preferably segmented to separate the independent objects, which can be performed by contour search, or through any similar known procedures. Larger objects can further be segmented for the more precise matching of inter-view changes, like rotations, distortions. Then the same objects or segments in the neighboring views are identified, their relative displacements between the neighboring views or the average over the views are calculated, if they appear in more than 2 views. For that even more images can be used, where it is advantageous to determine the camera parameters accurately, then rectifying the view images accordingly. Using the corrected motion data or disparity the common relative motion vectors based on the real 3D geometry are generated. It may be unnecessary to determine the entire 3D geometry. Instead, determining some geometry-related information (in this case the displacements) about the 3D geometry of the 3D scene may be sufficient for generating the common relative motion vectors.

Once the motion vectors for segments sweeping across multiple views are determined, there will be no need to perform motion estimation between the views again and again, or not on the entire area that might even lead to different motion vector structures each time with the conventional motion estimation, but the same motion vector set, that is common over the views, can be used to reconstruct large number of views.

When using multiple cameras, arranged as an array, it is advisable to apply a suitable calibration process and keep the angular displacement between the cameras smaller, e.g. less than 10 degrees, in order to get reliable disparity maps from the algorithms. This is not a problem for synthetic content, where computer generated view images are precise, or even the 3D model or disparity maps are available by definition in a computer system. In this case, the geometry-related information for generating the common relative motion vector set 22 can be readily obtained from the computer system.

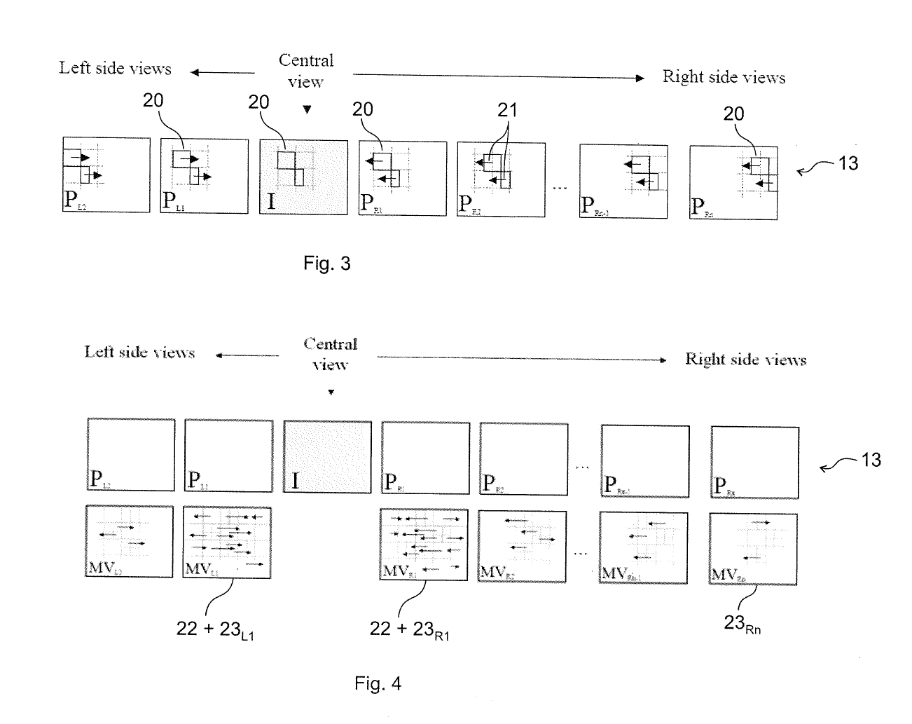

In the MPEG standard when transmitting predictive P or B frames, the motion vectors represent the majority of data relative to the residual image content. If we do not send through repeatedly the motion vector sets belonging to the P_{Rn}, P_{Ln} frames, where the common relative motion vectors are the same in case of predicted 2D view images of a 3D scene, just the changes only, related to the newly appearing details, the amount of data to be transmitted can be significantly reduced and we are also less dependent on the ability of the arithmetical encoder unit. This can be described as a common relative motion vector set referencing to relative positions displaced always with the same absolute values in the chain of reference frames. For example, if we have in P_{R1} a motion vector of −16 pixels, belonging to the block horizontally centered on pixel 200, referencing to the position of pixel 184 in the I frame; in P_{R2} on the pixel 216 the same relative motion vector will reference to pixel 200 of P_{R1} and the chain continues with the relative motion vector shifted according to its absolute value. FIG. 3 shows common relative motion vectors 21—depicted by arrows—describing displacements of an image part 20 (image segment) through all the views. These common relative motion vectors can be used in the invention instead of estimating and sending through individual motion vector sets over again with each P frame. Although the displacements of the image part 20 are the same over the views form one side to the other, the arrows are opposite on the two sides of the intra frame I as the displacements are here depicted with reference to the intra frame and then similarly at each frame with their preceding reference frames.

In the natural 3D approach a frame prediction matrix with left&right symmetry is expected, where the central view has a distinguished role. Keeping the central view provides 2D compatibility, while side views are predicted proceeding to the sides, moving away from the central position. Moving towards the sides view-by-view, the movement of the identical image parts 20, of a given depth, appearing on the views, will be equal view-by-view and in the opposite directions to the left and right views respectively, i.e. the motion vectors 21 will be the same, just their sign will be opposite on the left and right side views (more precisely in case of horizontal movements, there is no vertical component in the motion vectors, i.e. it is 0, and the sign of their horizontal component will be opposite having the same absolute value, e.g. +5 pixels, −5 pixels, as in FIG. 3.

According to standard MPEG coding conventions, motion vectors always belong to predictive frames, as in FIG. 4. In case of a 3D content containing 2D view images of a 3D scene, the P_{R1} and P_{L1} frames predicted from the I frame will show strong dependency, with corresponding image parts' displacements described by motion vectors of the same absolute values however with opposite horizontal directions. The arithmetical encoder, part of the MPEG entropy encoding, identifies the repeating patterns in the bit stream, thus the repeating motion vector sets of high similarity, in the P_{R1} and P_{L1} pictures, will be compressed rather effectively. There is, however, an advantageous way for further optimization.

While images (intensity maps) can change, the color, the brightness of objects in the views can be different, particularly at shiny, high-reflectance surfaces, the geometrically correct disparity maps or motion vector sets, belonging to the frames, coincide since the depth of objects does not change over the views. As explained, no need to send them through repeatedly, just to add the newly appearing details. In FIG. 4 motion vector sets are depicted, which are applicable for the prediction of the individual pictures. It can be seen that the motion vector sets for the first predicted pictures starting from the intra frame I are more dense, because those contain all the motion vectors of the common relative motion vector set 22 and additional motion vectors, that will be common at some i.e. sub-set of the predictive 2D view frames, referred as additional relative motion vector sets 23_{R1}, 23_{L1}, respectively. Further motion vector sets towards the sides contain only additional relative motion vector sets 23_{Rn}, 23_{Ln}, corresponding to the changes of newly appearing details. In practice this can be achieved through subtracting disparity maps or motion vector sets and as a result these additional relative motion vector sets, belonging to the views towards the sides, are almost empty, enabling highly efficient encoding.

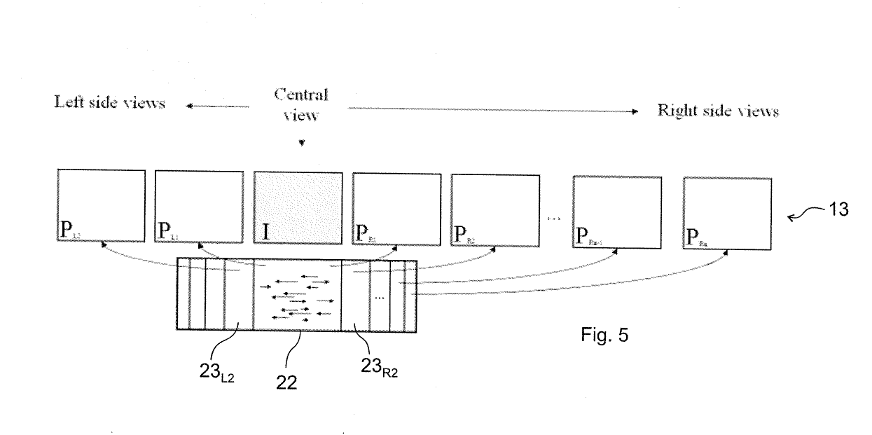

As depicted in FIG. 5, it is also possible to generate one single merged disparity map/motion vector set, consisting of the common relative motion vector set 22 and the additional relative motion vector sets 23_{R2-Rn}, 23_{L2-Ln} containing geometrical information on all the visible image parts, or pixels that become visible from a certain viewing angles, sufficient to send through only once.

Through such available geometry and intensity data large number of views can be generated, even exceeding the original number of camera images, reconstructing a quasi-continuous 3D light field.

In a preferred symmetric frame prediction structure, the 2D view image corresponding to the central view is an intra-frame I, while left and right side 2D view images are preferably predicted frames P_{R1-Rn}, P_{L1-Ln} sequentially predicted starting from the intra frame.

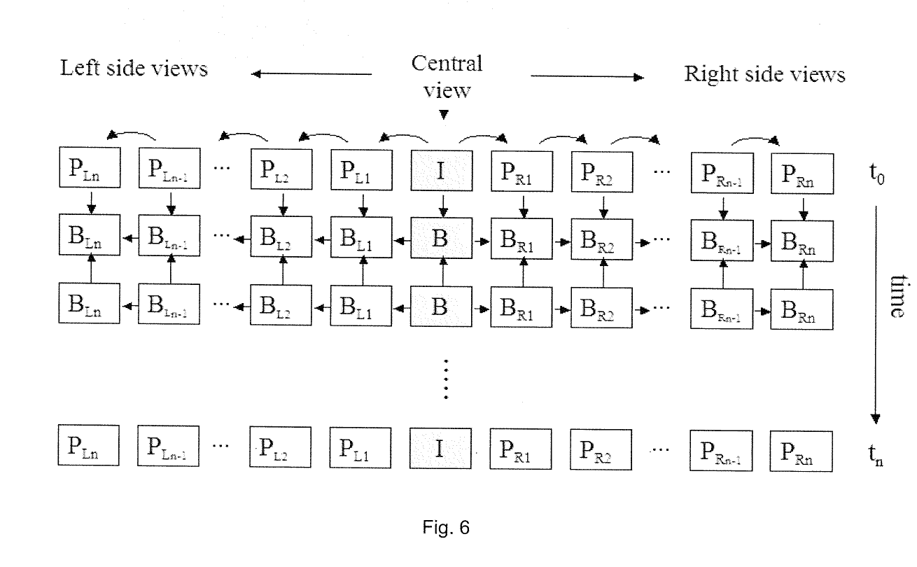

A possible scheme of a MPEG-4/H.264 AVC, MVC compliant inventive symmetric frame prediction structure is shown in FIG. 6. The rows of pictures represents 2D view images at a time point. The prediction in the rows can be carried out according to FIG. 4 or 5, while the temporal prediction is preferably carried out in line with the above mentioned standard.

A symmetric frame prediction structure is advantageous to keep the significance of the central view, as the basis for the 2D compatibility. It also implies the possibility of parallel processing to left and right sides simultaneously, having multiple encoders (in a basic configuration left-central-right) sharing the same common relative motion vectors from the 3D geometry module.

In the MPEG coding better compression rates can be reached by the use of larger group of pictures (GOP), containing one I frame with more P and B frames, at the expense of limited editability having less cut points. At the 3D view picture coding the postproduction editing cuts do not make an issue, since the view frames belong to the same time instance, thus advantageously it is possible to use long GOP-s, even of various frame prediction structures (I P P . . . P, or I B P B . . . etc.), for efficient compression rates.

For displays having multiple independent views, e.g. a basic 2 view zones situation, when the viewer on the left sees an other 3D scene than the viewer on the right, a further possibility is to display different 3D content on the left side and another on the right side. For such a content, analogous to the cuts between the GOP-s in time domain, it is possible to have side-wise independent views with the corresponding motion vector sets, similarly as on FIG. 4, but different on the two sides, or in general different sets for the independent viewing zones.

In H.264 AVC a variable block size segmentation is allowed, and motion vectors can be assigned to 16×16 pixel macroblocks, down to 4×4 pixel microblocks. The variable block size allows an accurate segmentation, corresponding to the independent objects in a 3D scene, to build up well-predicted views by moving the segments. The 4×4 blocks are useful at the contours, reducing residuals, while macroblocks work well on larger object areas, balancing the amount of motion vector data.

In the average 3D scenes, however, there are fewer, larger area objects. At a segmentation that is based on real 3D geometry, interpreting the 3D scene, identifying objects through their relative displacement in the views, it is possible to further decrease number of motion vectors assigning vectors to the objects rather than to regular blocks. This separation matches better any 3D scenes and enables a targeted dense description, decreasing the amount of data.

A further advantage of the inventive light field approach is the scalability. Among the frames encoded and transmitted according to scheme in FIG. 6, we have the central view stream that provides the 2D compatibility with decoders of proper settings, skipping the unnecessary frames, retrieving the full 2D stream. For stereo content two views are available, or even it is possible exploit one view and a motion vector set or two views and the corresponding two motion vector sets (disparity/depth maps) for additional image processing. It is also possible to extract narrow angle FOV, few view multiview content, typical at 5-9 view autostereoscopic (lenticular, parallax barrier) displays. Of course, similarly as we can see lower resolution e.g. mobile shot content on HDTV screen, having a high-end 3D light field display and decoder, we can exploit the full 3D information as well, benefiting high-quality full angle (wide angle FOV), broad baseline 3D light field content.

The 3D light field can be represented by a large number of images, either computer generated or camera images. In practical cases it is difficult to use large number of cameras, thus a 3D scene acquisition can be solved advantageously by a few, typically 4-9 cameras (in case of stereo content 2 cameras). This can be considered as a sampling of the 3D light field, however, with proper algorithms it is possible to reconstruct the original light field, calculating the intermediate views by interpolation, moreover it is also possible to generate views outside of the camera acquisition range by extrapolation. This can be performed either on the encoder (sender) side or the decoder (receiver) side, however for the efficient compression it is better to avoid increasing the amount of data to be transmitted.

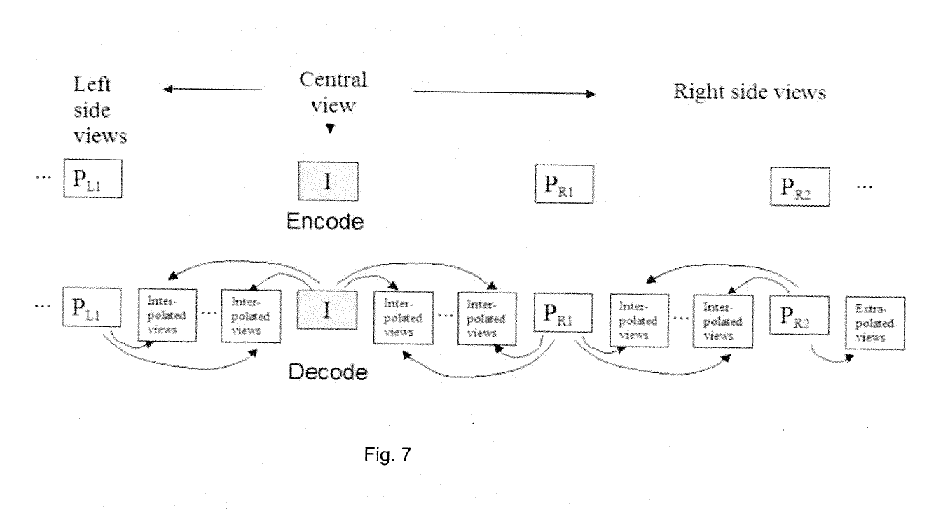

It is sufficient to encode the source camera images only and the decoder can generate the additional views necessary for the high quality 3D light field displaying by interpolation and/or extrapolation, as shown in FIG. 7. The complexity of the inter/extrapolation process can significantly be reduced, enabling real-time operation, using the geometrically correct motion vectors, i.e. the common relative motion vector set. On the encoder side it is possible to apply stronger computational capacity to generate the 3D geometry based motion vectors, i.e. disparity/depth maps, while the decoders can use these to generate the additional views with less hardware demand.

With practical terms at a source material comprising e.g. 15 2D view images 13 shot from a 3D scene 11 with 10 degrees angular displacement between the cameras, equal altogether to a 140 degrees FOV material, for a light field display, typically having 1 degree angular resolution, generating 10 interpolated views between the original views (plus extrapolating another 10 degrees at the side to widen the FOV) would match exactly the display capabilities, enhancing visual quality. In general this is a useful tool to match displays with different view reconstruction capabilities, i.e. light field displays with different angular resolution, or multiview displays with different number of views, enabling the compatible use of scalable 3D content.

An additional option is available for the decoders, which are able to generate views by interpolation and extrapolation using 3D geometry based disparity or depth maps, to manipulate the 3D content on the user side, for subtitling tag on the scene, controlling the convenient depth of individual objects on demand, or align the depth budget of the content to the 3D display's depth capability.

At the 3D content the horizontal parallax is much more important than the vertical. In case of 3D acquisition, like at stereo shooting, the cameras are arranged horizontally, consequently the view images contain horizontal parallax information only (HOP). The same applies to the synthetic content, as well. Therefore, to enhance the efficiency of the compression and to simplify the encode/decode process it is sufficient to determine and code horizontal motion vectors, i.e. the horizontal component only, since the vertical is 0, because in case of correct geometry the image parts will also show horizontal only displacements as of their depth.

In the MPEG process P and B pictures are used in various prediction structures to enhance the compression efficiency, though the quality of such images is lower along with the lower bit-rate. The bit-rate indicates the amount of compressed data, the number of bits transmitted in a second. For HD material this can range from 25 Mbit/sec to 8 Mbit/sec, however in case of lower visual quality requirements it can even go down to 2 Mbit/sec. As of the size, I frames are the biggest, than P frames and B frames are below with an additional ˜20%. The plentiful usage of P and B frames can be allowed at temporal compression, because the human vision is less sensitive to the short time quality changes. In case of coding 2D view pictures of a 3D scene this is different for the various prediction structures, since there are no viewing zones allowed of lower visual quality. At the spatial prediction, however, we can take the advantage of different significance of the central views and the sides. We can compress the views nearer to the central view with lower loss, while for the views towards the sides, of less importance to the viewers, we apply frame types and coding parameters that provide stronger compression, to enhance efficiency and reduce bit-rate.

The motivation of the known MVC standard is to exploit both the temporal and spatial inter-view dependencies of streams shot on the same 3D scene to have gain in the PSNR (peak signal to noise ratio, representing visual quality relative to the source material) and to save in the bit-rates. The MVC performs better for coding frames containing 3D information, while at certain scenes there is no observable gain.

It is possible to enhance the coding efficiency in algorithms referencing on multiple frames, exploiting both the temporal and spatial inter-view correlations simultaneously by using the inventive 3D geometry based common relative motion vector structure, corresponding to the separate 3D objects/elements in the 3D scene. Such objects move independently and their allover structure can be described with high fidelity by such motion vectors. In case motion vectors based on true 3D geometry and disparities are applied for the temporal motion compensation as well, very effective compression algorithms will be obtained.

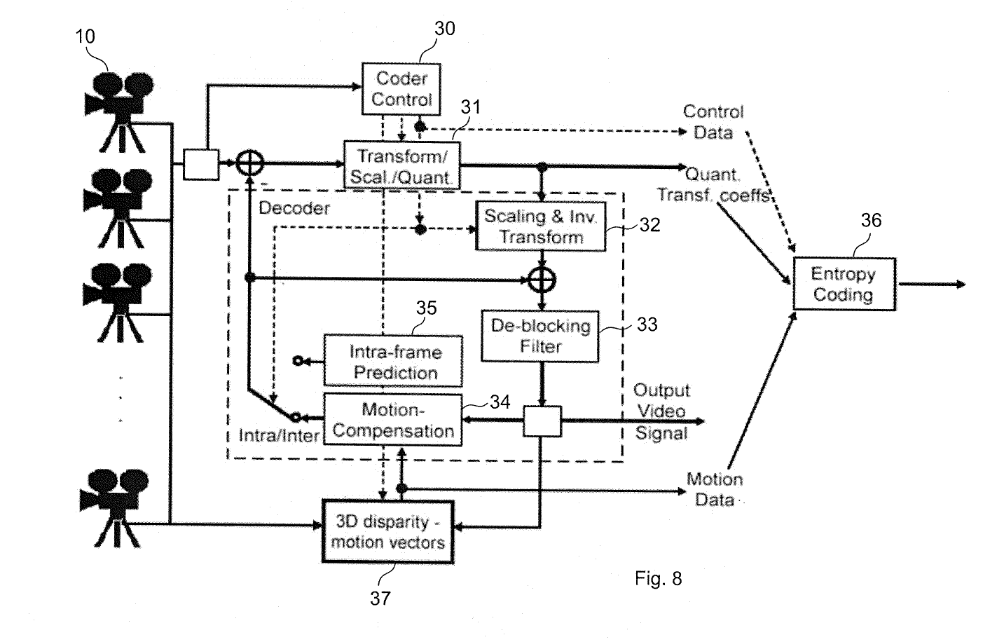

FIG. 8 shows a block diagram of an inventive coding apparatus, being a modified MPEG4/H.264 AVC encoder. The compression is based on exploiting the correlation between spatially adjacent points in the frames, intra-frame coding, and on the temporal correlation between different frames, inter-frame coding. The coding apparatus is controlled by a control module 30. In the first step, in a Transform/Scal./Quant. module 31, the video input images are prepared for the DCT (discrete cosine transformation), quantitization, then for the entropy coding in module 36 that accomplish the real compression. In the coding apparatus, there is also a decoder loop implemented (encircled by dashed line) to perform the inverse processes, (see Scaling & Inv. Transform module 32, De-blocking Filter module 33, Motion Compensation module 34 and Intra-frame Prediction module 35), the same steps all the other decoders will do at the receiver side. Using the decoded images the encoder can remove of the temporal redundancy by subtracting the preceding frame from the current one and coding the residuals only (inter-frame coding). It is known that images do not change too much from one instant to the other, rather certain objects move, or the whole image is shifted e.g. in case of camera movements, thus the efficiency of the compression process can greatly be improved by the motion estimation and compensation steps.

In the conventional MPEG4/H.264 AVC MVC standard, motion estimation is performed on blocks of the image, through searching the best matching block in the pervious image. The difference in the position of the best matching block in the previous image relative to the actually searched block is the motion vector. The blocks and motion vectors are coded and the decoder generates the predicted frame in the motion compensation step (in Motion Compensation module 34), by placing the matched blocks from the referenced frame to the position, determined by the motion vectors, in the current frame. Through the feedback to the encoder input the residuals are calculated by subtraction, so that the decoders on the receiver side can generate pictures, using the motion vectors belonging to the blocks, corrected with the residuals. The inventive coding apparatus differs from this conventional technique in that instead of simple motion estimation, the inventive real 3D geometry based common relative motion vectors are determined in a 3D disparity motion vectors module 37.

It can be seen that very effective coding method and decoding methods and apparatuses are obtained, that can perform inter-view compression with a high efficiency, as well as enabling reduced storage capacity and the transmission of true 3D, broad-baseline light-field content in a reasonable bandwidth.

The invention is not limited to the shown and disclosed embodiments, but further improvements and modifications are also possible within the scope of the following claims.

1. An image coding method for coding motion picture data comprising 2D view images (13) corresponding to spatially displaced views (12) of a 3D scene (11), comprising the step of
obtaining geometry-related information about the 3D geometry of the 3D scene (11) by
identifying corresponding image parts (20) in the 2D view images (13) of the 3D scene (11), and
determining the displacements of the corresponding image parts (20) over the 2D view images 13 the displacements being a consequence of the 3D geometry of the 3D scene 11, characterized by
generating a common relative motion vector set (22) on the basis of the geometry-related information, the common relative motion vector set (22) containing motion vectors determined according to geometry based relative displacements of the corresponding image parts (20) for at least some of the 2D view images (13), the common relative motion vector set (22) being common for said at least some of the 2D view images (13) and referencing to relative positions displaced always with the same absolute values from one view to the adjacent one, and
carrying out inter-frame coding by creating predictive frames (PR1-Rn, PL1-Ln)—starting from an intra frame (I), being one of the 2D view images (13)—for said at least some of the 2D view images (13) of the 3D scene (11), on the basis of the intra frame (I) and the common relative motion vector set (22).

2. The method according to claim 1, characterized in that the 2D view images (13) are segmented into blocks and motion vectors are associated to the blocks.

3. The method according to claim 1, characterized in that the intra frame (I) is a 2D view image (13) corresponding to a central view of the 3D scene (11), and the inter-frame coding is carried out from the central view towards the side views.

4. The method according to claim 1, characterized by comprising the steps of generating additional relative motion vector sets (23R1-Rn, 23L1-Ln) for at least some of the predictive frames (PR1-Rn, PL1-Ln).

5. The method according to claim 1, characterized in that coding efficiency is enhanced by reducing bit-rate by compressing the 2D view images (13) nearer to a central view with lower loss, while for the 2D view images (13) towards sides applying frame types and/or coding parameters that provide higher compression rate.

6. The method according to claim 1, characterized by applying a parallel processing on a symmetric prediction structure for the two sides of the central view by multiple encoders sharing the common relative motion vector set (22).

7. The method according to claim 1, characterized by using the common relative motion vector set (22), corresponding to objects in the 3D scene (11), to generate temporal motion vectors for the objects for temporal prediction of images succeeding in time.

8. The method according to claim 1, characterized by generating the motion vectors (21) on the basis of the best matching block structure according to the H.264 AVC standard.

9. The method according to claim 1, characterized in using an object based motion vector structure, wherein the corresponding image parts (20) are objects or parts of objects in the 3D scene (11) and motion vectors of the common relative motion vector set (22) belong to the objects or the part of objects.

10. The method according to claim 1, characterized in that the 3D scene (11) generated by a computer system, and the geometry-related information is obtained from the computer system.

11. The method according to claim 1, characterized by comprising the steps of,
determining the geometry of the 3D scene (11) and the disparity of identical image parts (20) over the views (12),
replacing the motion estimation step of a standard video coding process by generating the motion vectors (21) based on the determined 3D geometry, and
processing the generated motion vectors (21) according to the MPEG process.

12. The method according to claim 1, characterized by using horizontal only common relative motion vectors (21) in encoding horizontally displaced 2D view images (13) of the 3D scene (11).

13. An image decoding method for decoding motion picture data coded with the method according to claim 1, characterized by comprising the step of
carrying out inter-frame decoding for reconstructing 2D view images (13) of the 3D scene (11) on the basis of the intra picture (I) and the common relative motion vector set (22).

14. The method according to claim 13, characterized by comprising the step of
carrying out inter-frame decoding for reconstructing 2D view images (13) of the 3D scene (11) on the basis of reference frames (I, P or B) using the common relative motion vector set (22) and the additional relative motion vector sets (23R1-Rn, 23L1-Ln).

15. The method according to claim 13, characterized by comprising the step of generating additional 2D view images corresponding to further views of the 3D scene (11) by carrying out interpolation and/or extrapolation on the basis of the common relative motion vector set (22).

16. The method according to claim 13, characterized by changing the geometry of the 3D scene (11) during decoding by generating 2D view images corresponding to changed depth parameters of the 3D scene (11).

17. An image coding apparatus carrying out the image coding method according to claim 1.

18. An image decoding apparatus carrying out the image decoding method according to claim 13.

19. A computer readable medium storing computer executable instructions for causing the computer to perform the image coding method according to claim 1.

20. A computer readable medium storing computer executable instructions for causing the computer to perform the image decoding method according to claim 13.
